(19) United States
(12) Patent Application Publication
(10) Pub. No.: US 2008/0089551 A1
(43) Pub. Date: Apr. 17, 2008

(54) Interactive TV data track synchronization system and method

(76) Inventors: Ashley Heather, New York, NY (US); Alberto Escarlate, Westport, CT (US); Mathew Robinson, New York, NY (US)

Correspondence Address: KENYON & KENYON LLP, ONE BROADWAY, NEW YORK, NY, 10004, US

(21) Appl. No.: 11/582,095

(22) Filed: Oct. 16, 2006

(51) Int. Cl. G06K 9/00; H04N 7/167

(52) U.S. Cl. 382/100; 380/200

(57) ABSTRACT

The present invention provides a system and method to allow product placement, i.e. showcasing products broadcast over TV, cable or similar media and to enable viewers to view, bookmark and purchase products placed within the program as they appear on the TV screen at a particular time. The present invention further provides a method and system for creating and identifying a digital fingerprint, which consists of a record of one or more frames in a program and associating information about products that appear in these frames to the digital fingerprint. The fingerprints are stored in a database of digital fingerprints, accessible via a wireless network and the Internet from the viewer's mobile wireless device. The mobile device submits a request to identify and locate the fingerprints corresponding to the program frame(s) being viewed, and it receives and displays the associated product information in order to facilitate the purchase of the featured products.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### FIELD OF THE INVENTION

The present invention relates to a computerized system and method for enabling TV viewers to purchase products and locate marketing and product information about products appearing in any particular scene of a show or program being broadcast on TV, cable or similar broadcast media. More specifically, it pertains to a system and method for encoding information about products that appear in each frame (or set of frames) of the broadcast program, associating that information with a unique identifier and allowing the viewer to automatically search for and retrieve the associated product information based on a unique retrieval identifier for a particular frame or frames (at a particular moment in the program) and purchase the featured product(s) from the affiliated merchants, and/or bookmark and save the retrieved product information for purchase at a later time.

### BACKGROUND

From the earliest days of television, retailers and vendors of consumer goods and services used the television medium to promote their products and encourage viewers to purchase their goods and services. Typically, this was done using commercials, infomercials, home shopping networks, and other types of direct selling. As e-commerce over the Internet became more popular among consumers, they generally became accustomed to greater flexibility and instant access to merchants, vendors, and manufacturers, and to marketing information for the products and services advertised or shown in the media, including television. The direct marketing companies attempted to fulfill consumers' requirements and expectations through use of TV home shopping networks or businesses, whereby vendors and distributors could market and sell their products directly to TV viewers and also provide information about affiliated e-commerce websites where additional product or vendor information could be accessed by viewers.

This solution, however, fails to provide the flexibility and instant access to merchant and product information that is sought by viewers. First, home shopping networks are controlled by a limited number of companies that require a complex and costly partnership with the merchants that advertise their products on the shopping network channels. Second, viewers do not have the flexibility of ordering products or receiving product information about items that they actually see displayed on the TV screen as they view content (game shows, movies, soap operas, concerts, sports, etc.) without actually switching channels or in any other way interrupting or interfering with viewing of the content. Other alternatives, such as, for example, a broadcast-synchronized interactive TV content system described in the published patent application no. 2002/0162117, suggest a display of certain selected products and related product information in the partitioned TV screen. This solution, however, also fails to address viewers' desire to see the TV content free of extraneous interferences, but, nevertheless, to be able to access information about the products appearing as part of the viewed content.

Therefore, there exists a need for, among other goals and solutions, a system and method to synchronize and obtain information about products being featured as part of the TV broadcast content, including, without limitation, the products appearing in the scene, clothes worn by the actor and other product- and merchant-related information, and to allow viewers to access this information and purchase the desired products from the affiliated merchants, as the viewer enjoys broadcast content without any cumbersome and undesired interference with the viewing, such as the need to switch channels or to partition the TV screen.

### SUMMARY OF THE INVENTION

One aspect of the interactive TV data track synchronization system and method according to the present invention is to allow product placement, i.e., showcasing products (either goods or services) within an entertainment production or broadcast over TV, cable or similar media (program), and to enable viewers to view, bookmark, and/or purchase products placed within the program as they appear on the TV screen at a particular time. The present invention also covers systems in which the broadcast program is stored in memory, as, for example, on a digital video recording (DVR) device and played by the viewer at a later time. Another aspect of the present invention is to permit viewers to receive product information and information related to merchants from which the products appearing on the TV screen can be purchased. The product and merchant information may also be listed on a mobile device and bookmarked for future purchase on-line or in a physical store.

An additional aspect of the present invention is to provide a method and system for creating and identifying a digital fingerprint, which consists of a record of one or more frames in a specific piece of programming and associating products that appear in the stored frames to the corresponding fingerprint. A still further aspect of the present invention is to provide a method and system for storing the digital fingerprint and product information associated with a particular show in a database, which may include, but is not limited to, a local cache database and/or a master database of digital fingerprints, accessible via wireless network and/or the Internet. The database of digital fingerprints, in accordance with the present invention, is searched for a particular fingerprint and related product information requested by the viewer. Once the requested fingerprint is located, the database transmits the fingerprint and related product information to the viewer's mobile wireless device, which may be, without limitation, a cellular telephone, personal digital assistant (PDA), portable music player, specialized remote control device or some other type of mobile wireless device that is capable of transmitting and receiving wireless signals and displaying information related to the products that appear as part of a particular program viewed on TV.

Yet another aspect of the present invention is to provide a system and method for dividing a program into the segments or fingerprints, determining which products appear in a particular program segment or frame and associating product information, including, without limitation, the image of the product, merchant information, product marketing data or other product-related metadata to the corresponding fingerprint(s).

The present invention provides a computerized system and method that utilizes digital fingerprinting methodology to attach product metadata to the corresponding digital fingerprint(s) for each scene or frame in a program. It provides a method and system to identify the program being viewed by the viewer, determine which particular scene or frame in that program is being broadcast at a particular time, search in the local and/or remote databases for the products appearing in the identified scene or frame(s), and to allow viewers to receive and view the product information associated with the requested scene or frame(s) on a wireless remote device. The received information may include a Web address of a distributor or vendor that sells a particular product that appears in a scene being viewed by the viewer, marketing information about that product and other information designed to facilitate the purchase of that product by the viewer.

These and other objects, features and advantages of the present invention may be best understood from the following detailed description of the embodiments of the present invention, taken in conjunction with the accompanying drawings.

### BRIEF DESCRIPTION OF THE DRAWINGS

FIG. 1 illustrates a generalized system and environment for implementing and practicing the method in accordance with one embodiment of the present invention;

FIG. 2 shows a flowchart of the operation of the system and method in accordance with one embodiment of the present invention;

FIG. 3 illustrates a generalized system and environment for retrieving the product metadata associated with a particular fingerprint and providing that product metadata information to the viewer; and

FIG. 4 shows a flowchart of the operation of the system and method, including the creation of the fingerprint database(s) and retrieval of the desired fingerprint and/or associated product metadata in accordance with one embodiment of the present invention.

### DETAILED DESCRIPTION

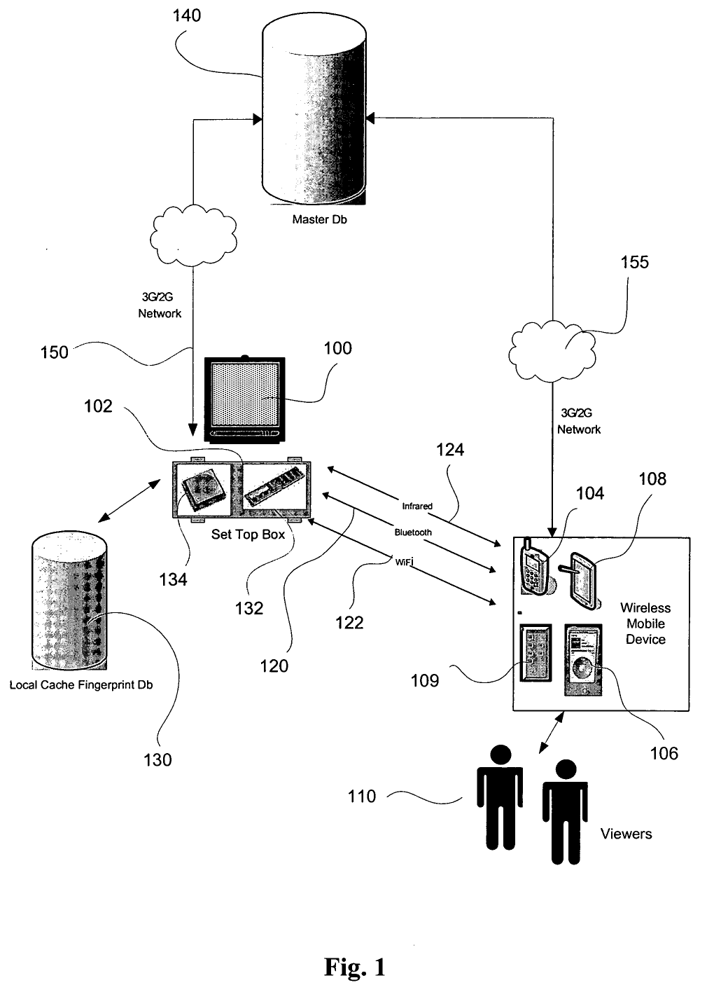

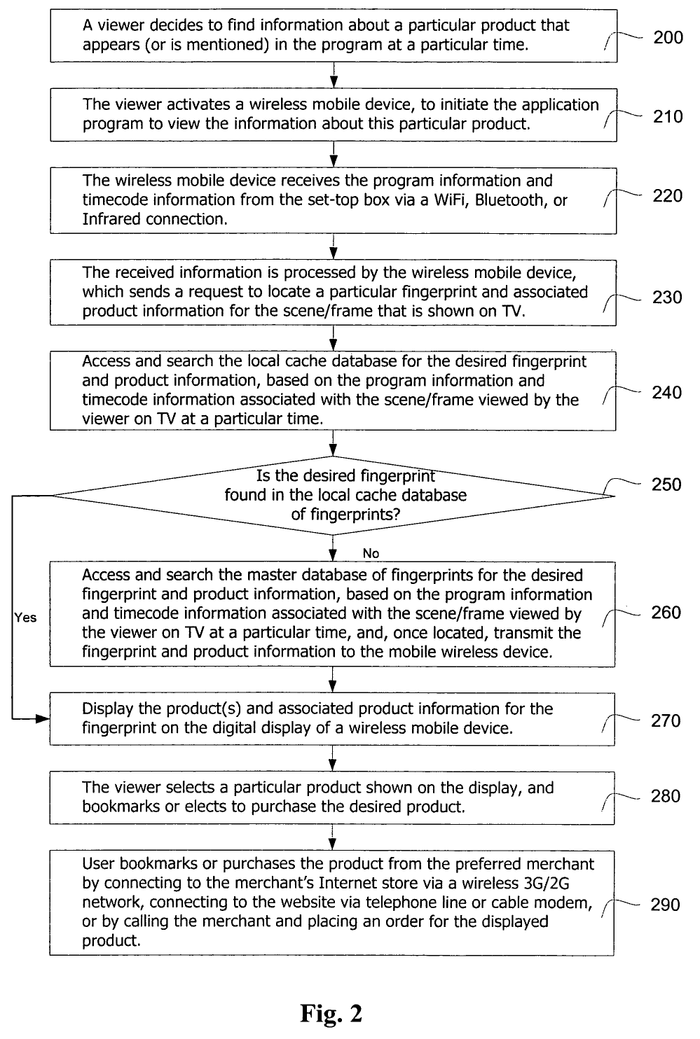

A system and method, in accordance with one embodiment of the present invention, is shown with references to FIGS. 1 through 4. FIG. 1 illustrates a general environment and operation of the system and method, in accordance with the present invention, in which a television (TV) set 100, with a set-top box 102 and a wireless mobile device, such as, for example, a cell phone 104, a portable music player 106 or a personal digital assistant (PDA) 108 is operated by a viewer 110, who is watching a program on a TV set 100. In an alternative embodiment, the wireless mobile device may be a remote control device 109, and the set-top box 102 could be built into the TV set 100.

The communication between the wireless remote device and the set-top box 102 or the TV set 100 may use wireless transmission media, such as, but not expressly limited to, the Bluetooth® communication protocol 120, WiFi communication 122 or an Infrared (IR) connection 124, the latter commonly used with TV and cable remote control devices. The set top box 102 may store a local cache database 130 in a computer memory 132 of the set-top box 102. In the alternative, the local cache database 130 may be located in the computer memory of another device, either locally located or accessible through a computer network (not shown) having the computer memory 132 and a processor 134 for processing the stored fingerprint information and operating to update and store in the local cache database of fingerprints 130 the additional information received via a 3G/2G wireless network 150 (or through a connected cable network) from a master database of digital fingerprints 140. The master database 140 may be external to the set-top box and the TV set 100, and may reside on a server that is accessible via a dedicated network and/or through the Internet 155. The local cache database of fingerprints 130 may contain a subset of all fingerprints stored in the master database of fingerprints 140 for the programs shown on multiple channels at different time slots.

The operation of the present system and method is further explained with reference to FIGS. 1, 2 and 3. A viewer 110 watching a program on TV set 100 decides to find information about a particular product that appears (or is mentioned) in the program at a particular time at step 200. The viewer activates a wireless mobile device 300 to initiate an application program, processed by a processor 330, requesting to view information about a particular product at step 210. The wireless mobile device may receive the program information and timecode information from the set-top box 102 via a WiFi 122, Bluetooth 120 or Infrared 124 connection at step 220. This information is processed at step 230 by the processor 330 in the wireless mobile device and utilized to issue a request to locate a particular fingerprint that is associated with the program and the scene or frame that is shown on TV at the time that the request for a particular product is initiated by the viewer. At step 240, the processor 134 in the set-top box 102 initiates a search inquiry into the local cache database 130, which may reside in the memory 132 of the set-top box device, to locate the desired fingerprint and product information associated with that fingerprint based on the program and timecode information received from the set-top box 102. For example, the program being shown on a channel that is viewed by the viewer is identified, and the timecode, which relates the timing of the particular scene or frame from the beginning of that program, is determined.

In an alternative embodiment (not shown), the local cache database 130 is located in a computer memory that is external to the set-top box; for example, it may be stored in the computer memory of a viewer's personal computing device, which can then be accessed via a wireless communication protocol, including, but not limited to, WiFi, Bluetooth and Infrared communication methods, by the wireless mobile device 300. The wireless mobile device 300 operates to submit a request to search for and locate a fingerprint and/or product information associated with that fingerprint in the local cache database.

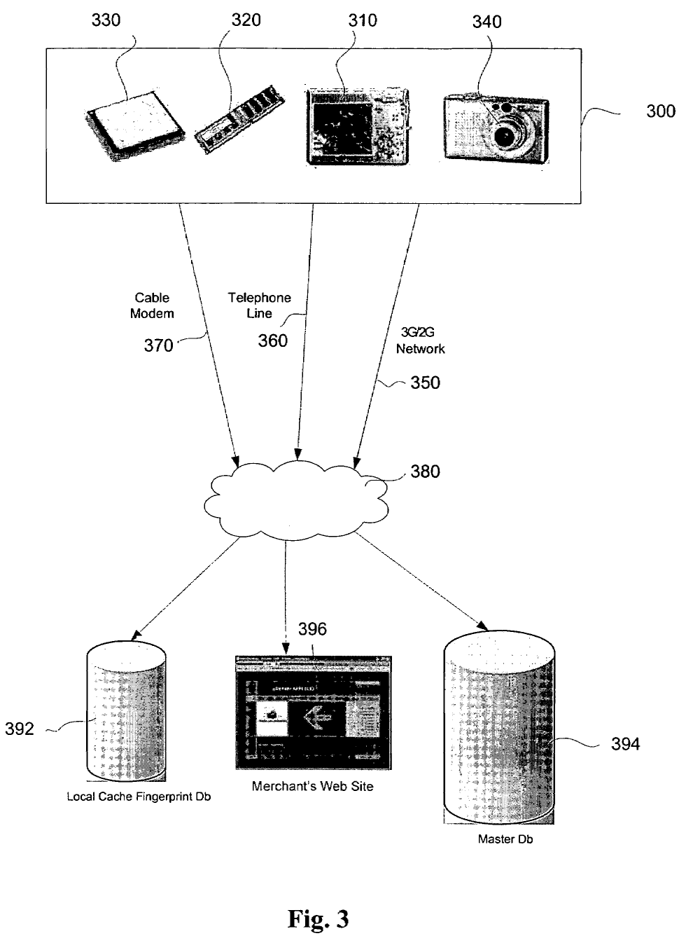

If the requested fingerprint information is not found in the local cache database 130 at step 250, a request is issued to search for and locate the desired fingerprint and product information in the master database 140 via a 3G/2G network, which could either be a dedicated network or could utilize the Internet for accessing the master database 140 of fingerprints at a remote location or server. The located fingerprint and/or product information is transmitted at step 260 from the master database 140 (or from the local cache database 130, if found to be there) to the wireless mobile device 300, either directly or through the set-top box 102 and/or an additional router(s). Subsequently, at step 270, the fingerprint information, including without limitation the picture of the located product and other product information are displayed on the digital display 310 or LCD of a wireless mobile device 300. As shown in FIG. 3, the wireless mobile device 300 comprises a digital display 310, a computer memory 320 and a processor 330 that operate to allow the user to view products that correspond to the fingerprint of a program scene or frame appearing on TV, to request additional marketing information, and/or to obtain information about merchants that sell a particular product, as indicated in step 280. In addition, the viewer may also elect to bookmark the product for later viewing or decide to purchase the product from a merchant, either by connecting and placing an order with the merchant's Internet store 396 via a wireless 3G/2G network 350, a telephone line 360 or a cable modem 370, and via the Internet 380, or by calling the merchant and ordering the desired product that appeared in the viewed program, as shown in step 290.

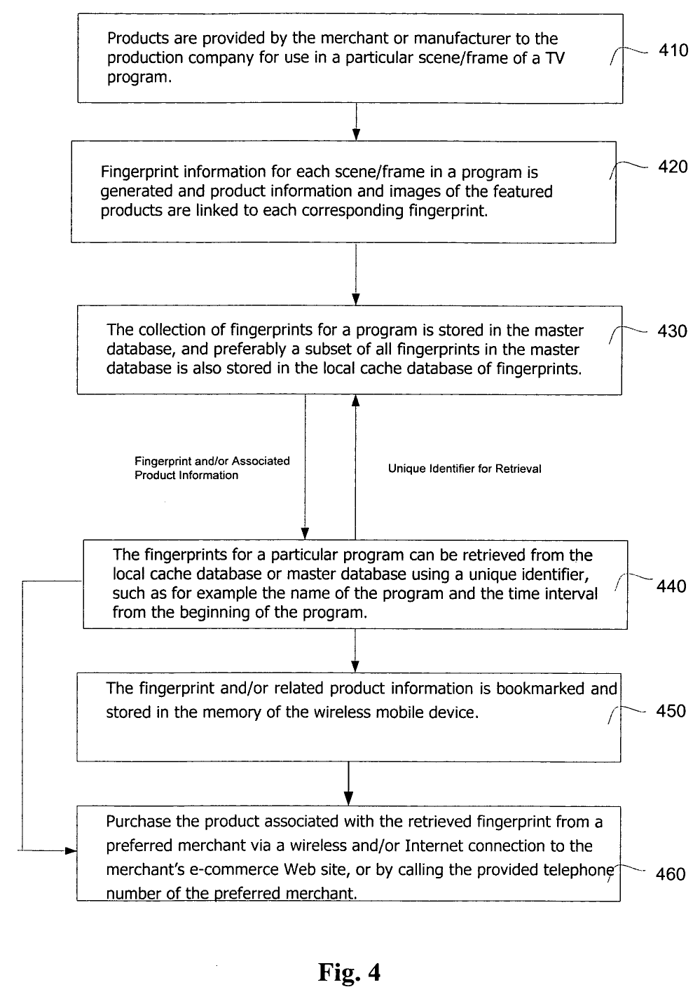

The digital fingerprinting methodology and retrieval techniques utilized with the present system and method are further described with reference to FIG. 4. Generally, one commonly used type of product placement, known as a “direct trade,” involves supply of a particular product or service by the merchant or manufacturer to the production company, which uses this product or service in a particular scene/frame of a TV program. This is shown as step 410 of FIG. 4. Thus, information about products utilized in a particular program is known and available to the production company and can be associated with each corresponding scene or frame of the final version of the program, as shown in step 420. This information can be stored as part of the fingerprint database in the master database and/or, additionally, in the local cache database for the program, or, alternatively, transmitted together with the content of the program to the TV set and/or set-top box at step 430. Each fingerprint relates to one or more frames making up a particular scene (at a particular point in the program's time sequence) in which one or more products are featured. For example, it could include information about the clothing worn by an actor and furniture used in the set. Once the scene is changed, and additional products are added to the frame/set, another fingerprint is generated and those additional products are associated with this new fingerprint. The program information, such as, but not limited to, the name program, the time when it is shown and the time interval from the beginning of the program may be stored as part of the fingerprint information, or it may be stored separately and associated with the corresponding fingerprint.

The fingerprints for a particular program may be sorted and retrieved using a unique identifier, such as, for example, the name of the program and the time interval from the beginning of the program at step 440. Thus, each fingerprint is associated with a frame (or set of frames) of a program, and may be identified by a unique identifier, which serves as a key to retrieve the fingerprint and product information about one or more products that are featured in the frame(s) associated with a particular fingerprint. When a viewer decides to find out information about the featured product(s) (based on what the viewer sees at a particular point in the program's time sequence), the system may retrieve the fingerprint(s) for that particular frame (or set of frames), and may also retrieve the associated product and merchant information for the products that are featured in the program frame(s) at that particular point in the program's time sequence.

Alternatively, the retrieval could be based on any hashing algorithm that can uniquely identify a particular fingerprint based on a particular type of input, such as, for example, the background and foreground colors, object outlines, collection of points on the image or any other aspect of the image appearing on TV. It may also be based on the sampling of the sound track that corresponds to the scene or frame shown on TV. For example, the viewer could take the photo image of the scene/frame using the digital camera 340, built into the mobile wireless device 300, as shown in FIG. 3. The mobile device sends that digital image to the set-top box and/or the database of digital fingerprints for identifying the fingerprint and related product information that are being requested. Alternatively, the viewer could use a mobile phone 104, a portable music layer 106, a PDA 108 or a specialized remote control device 109, to transmit the sound track sampling that corresponds to the scene or several frames shown on TV. This sampled audio data may be utilized to determine which scene/frame of which show is being viewed and to locate the fingerprint and associated product information that is being requested by the viewer. The present invention may be utilized with time-shifted programs that are stored in a computer memory or some type of digital storage media, as, for example, using a DVR device to record the broadcast program. The above-mentioned methods could locate the associated fingerprint and product information based on a unique identifier for a particular type of input when the input data corresponds to the program frames that were recorded earlier and viewed at a later time.

Once retrieved, the fingerprint and related product information may be bookmarked and stored in the memory 320 of the wireless mobile device, as shown in step 450, or used to purchase the product featured in a particular scene/frame from a merchant via a wireless and/or Internet connection to the merchant's e-commerce Web site, or by calling the provided telephone number of a merchant in step 460.

Although the preceding text sets forth a detailed description of various embodiments, it should be understood that the legal scope of the invention is defined by the words of the claims set forth below. The detailed description provided herein is to be construed as exemplary only and does not describe every possible embodiment of the invention, because describing every possible embodiment would be impractical, if not impossible. It should also be noted that the sequence or arrangement of the particular steps shown in various figures accompanying the description of the embodiments of the current invention is not limiting, and it is understood that rearranging these described steps is within the scope of the contemplated invention. Numerous alternative embodiments could also be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principles disclosed and claimed herein.

What is claimed is:

1. The system for providing information about at least one product that is featured in a scene or a frame of at least one broadcast program, the system comprising:
a set top box having a processor and a memory, wherein the set top box is operable to receive the at least one program having a plurality of frames; and
a database of fingerprints, each fingerprint relating to at least one frame of the program, wherein each fingerprint comprises an identifying information about the program and about one or more products that appear in the program frames that are associated with that fingerprint;
wherein the set top box is also operable to transmit and receive the product information associated with the at least one fingerprint stored in the database.

2. The apparatus of claim 1, wherein the database of fingerprints comprises:
a master database containing a plurality of fingerprints, each fingerprint relating to at least one frame of the program; and
a local cache database containing a subset of the fingerprints stored in the master database, the local cache database operable to receive and store a plurality of the fingerprints from the master database.

3. The apparatus of claim 2, wherein the local cache database receives the plurality of the fingerprints from the master database via an access method selected from the group consisting of a wireless network connection, a cable connection and an Internet connection.

4. The apparatus of claim 1, wherein the set top box is built into a television set.

5. The apparatus of claim 1, further comprising:
a wireless mobile device having a processor, a memory and a digital display, the wireless mobile device being operable to receive the information related to the at least one fingerprint and one or more products associated with that fingerprint and to display the received product information.

6. The apparatus of claim 5, wherein the wireless mobile device is configured to bookmark and store the received information in a memory of the wireless mobile device.

7. The apparatus of claim 5, wherein the wireless mobile device is a device selected from the group consisting of a mobile telephone, a personal digital assistant, a portable music player and a remote control device.

8. The apparatus of claim 5, wherein the wireless mobile device is configured to receive the information related to the at least one fingerprint from the set top box.

9. The apparatus of claim 5, wherein the wireless mobile device is configured to receive the information related to the at least one fingerprint from the master database.

10. The apparatus of claim 9, wherein the wireless mobile device is configured to receive the information related to the at least one fingerprint from the local cache database that is external to the set top box.

11. The apparatus of claim 5, wherein the wireless mobile device is configured to connect to a merchant's Internet site and submit a request to purchase at least one product associated with the at least one fingerprint received by the wireless mobile device and corresponding to the product appearing in the one or more frames of the program.

12. The apparatus of claim 1, wherein the at least one fingerprint in the database is retrieved using a unique identifier.

13. The apparatus of claim 12, wherein the unique identifier comprises a name of the program and a time interval from a beginning of the program.

14. The apparatus of claim 12, wherein the unique identifier comprises an image content of at least one frame of the program.

15. The apparatus of claim 12, wherein the unique identifier comprises an audio sample corresponding to a plurality of frames of the program.

16. A method for providing information about a product that is featured in a scene or frame of at least one program, the method comprising the steps of:
receiving in a set top box a request to obtain a fingerprint information associated with at least one frame of the program, the fingerprint comprising an information about one or more products that appear in the program frame; and
searching in a database of fingerprints for the requested fingerprint information; and
transmitting the located fingerprint information and the information about one or more products that are associated with that fingerprint.

17. The method of claim 16, further comprising the steps of:
storing in the database of fingerprints a plurality of fingerprints, each fingerprint relating to the at least one frame of the program and containing an identifying information about the program and about one or more products that appear in the program frames that are associated with that fingerprint; and
updating the fingerprint information stored in the database of fingerprints.

18. The method of claim 16, wherein the step of searching the database of fingerprints consists of a search in a local cache database and a master database of fingerprints.

19. The method of claim 16, wherein the transmission of the located fingerprint and product information from the database is accomplished through the set top box.

20. The method of claim 16, further comprising the steps of:
receiving the fingerprint and product information from the database of fingerprints;
displaying the received product information on a display screen of a wireless mobile device; and
transmitting a request to purchase at least one product from a merchant, wherein the merchant information is based on the information stored in the database of fingerprints.

21. The method of claim 20, further comprising the step of:
book marking and storing the received information in a memory of the wireless mobile device.

22. The method of claim 16, wherein the searching in the database of fingerprints for the requested fingerprint information is performed using a unique identifier for the requested fingerprint.

23. The method of claim 22, wherein the searching in the database of fingerprints for the requested fingerprint information is performed using the unique identifier comprising a name of the program and a time interval from a beginning of the program.

24. The method of claim 22, wherein the searching in the database of fingerprints for the requested fingerprint information is performed using the unique identifier comprising an image content of at least one frame of the program.

25. The method of claim 22, wherein the searching in the database of fingerprints for the requested fingerprint information is performed using the unique identifier comprising an audio sample corresponding to a plurality of frames of the program.

26. A method for providing information about a product that is featured in at least one frame of a program, the method comprising the steps of:
storing in a database of fingerprints a plurality of fingerprints, each fingerprint relating to the at least one frame of the program and containing an identifying information about the program and related product information;
receiving a request to locate in the database of fingerprints a fingerprint associated with a particular frame of the program;
searching in the database for the requested fingerprint;
transmitting the located fingerprint and product information, wherein the transmitted product information comprises the information about one or more products that appear in the program frames that are associated with the located fingerprint.

27. The method of claim 26, further comprising the steps of:
receiving the product information from the database of fingerprints;
displaying the received product information on a wireless mobile device; and
transmitting a request to purchase at least one product from a merchant, wherein the product information was received by the wireless mobile device from the database of fingerprints.

28. A wireless mobile device having a processor, a memory and a digital display, the device being operable to send a request to locate at least one fingerprint associated with at least one frame of a program, and further operable to receive and display an information about one or more products that appear in the at least one frame of the program, wherein the received product information is associated with the located fingerprint.

29. The device of claim 28, wherein the wireless mobile device is operable to transmit a request to purchase at least one product from a merchant, wherein the merchant information is based on the product information received by the wireless mobile device from the database of fingerprints.
